(19) United States
(12) Patent Application Publication
(10) Pub. No.: US 2017/0092449 A1
(43) Pub. Date: Mar. 30, 2017

(54) CURRENT MANAGED DRIVE SYSTEM FOR ENERGIZING CONTACTORS AND OTHER COIL-BASED EXTERNAL LOADS

(71) Applicants: Christopher Derek Thornton, Saint Charles, IL (US); Adrian E. Vandergrift, Rockton, IL (US)

(72) Inventors: Christopher Derek Thornton, Saint Charles, IL (US); Adrian E. Vandergrift, Rockton, IL (US)

(73) Assignee: HAMILTON SUNDSTRAND CORPORATION, Charlotte, NC (US)

(21) Appl. No.: 14/867,627

(22) Filed: Sep. 28, 2015

(51) Int. Cl. H01H 47/22

(52) U.S. Cl. CPC H01H 47/22

(57) ABSTRACT

The disclosure herein relates to a current managed drive system for utilizing a current output to engage and hold a contactor. The current managed drive system includes the contactor comprising a single coil that has a momentary high pull-in current and a low hold current and a contactor coil drive configured to control the current output to the contactor to match the momentary high pull-in current to engage the contactor and the low hold current to hold the contactor.

### BACKGROUND

Embodiments herein relate generally to current managed drive systems, and more specifically, to current managed drive systems for energizing contactors and other coil-based external loads.

In general, contemporary contactor electrical systems of an aircraft include an output drive circuit that is used to control a contactor or solenoid valve. For example, when a voltage of an output drive circuit is applied to a coil of a contactor or a solenoid valve, that contactor or solenoid valve is engaged as a result of the current being passed through the coil.

Further, contemporary contactor electrical systems are specified in terms of a coil voltage, such as a minimum coil voltage to guarantee that the contactor or solenoid engages (or closes) under worst case operating conditions (e.g., high resistance under hot operating conditions). In another example, contemporary contactor electrical systems can be specified in terms of a maximum coil current applied by the output drive circuit when the maximum drive voltage is applied under conditions of minimum coil resistance (e.g., cold conditions or cold coil).

In accordance with these specified terms, contemporary contactor electrical systems can utilize a solid state switch (e.g., a transistor) to apply or remove the coil voltage and must be sized to deliver the maximum combination of current and voltage. With respect to cold conditions, the output drive circuit and supporting power source must be sized to provide the highest current demanded by the coil when the maximum voltage is applied. This places an excessive burden in terms of the power handling requirements on both the output drive circuit and the supporting power source. That is, both the output drive circuit and the supporting power source must be sized to handle more power than if the coil was energized with just the minimum required current and voltage that is necessary to operate it.

The above problem is further exacerbated when the solenoid or contactor is of a heavy duty type that requires a high current to initially engage the mechanism (and a much lower current to hold it). These contactors are typically fitted with two coil connections or taps; one being a heavy (high-current) coil to engage or close the mechanism, and the other a lighter coil (requiring less current) to hold the mechanism closed.

### SUMMARY

Embodiments relate to current managed drive system for utilizing a current output to engage and hold a contactor. The current managed drive system includes the contactor comprising a single coil that has a momentary high pull-in current and a low hold current and a contactor coil drive configured to control the current output to the contactor to match the momentary high pull-in current to engage the contactor and the low hold current to hold the contactor.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a current managed drive system in accordance with an embodiment; and

FIG. 2 illustrates another current managed drive system in accordance with an embodiment.

### DETAILED DESCRIPTION

Embodiments described herein relate to current managed drive systems, and more specifically, to current managed drive systems for energizing contactors and other coil-based external loads.

In general, a current managed drive system comprises a contactor (or solenoid) and a contactor coil drive designed to manage and control the current (rather than voltage) needed to operate the contactor. The contactor coil drive further comprises an efficient drive circuit based on a switched-mode power regulator. The contactor incorporates a single coil or coil connection. Utilizing the efficient drive circuit and the switched-mode power regulator, the contactor coil drive through the single coil manages a current to provide a high current to initially engage the contactor and a lower value to keep the mechanism closed (e.g., the high current is limited to the lower value).

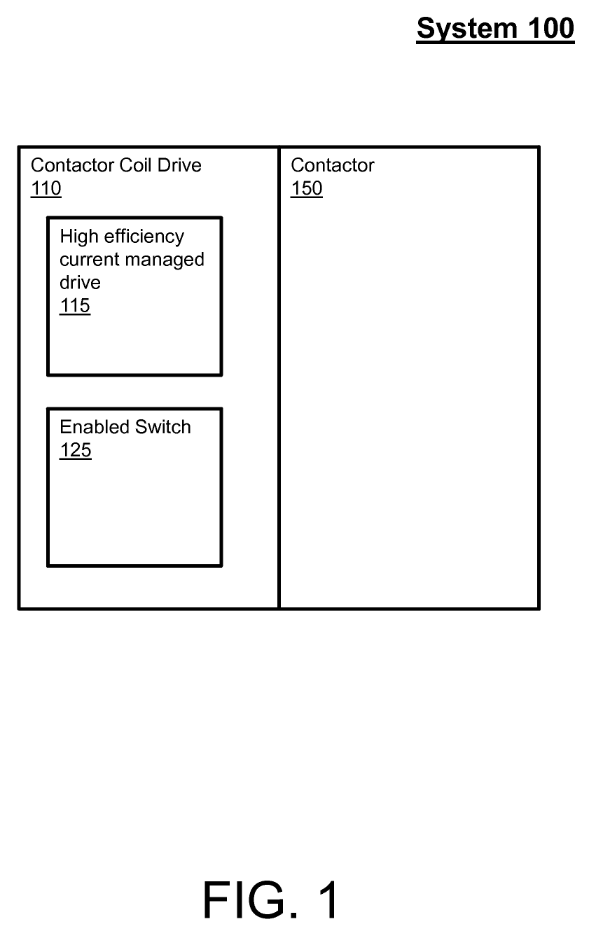

Turning now to FIG. 1, a current managed drive system 100 that includes a contactor coil drive 110 comprising a high efficiency current managed drive 115 and an enabled switch 125. The system also includes a contactor 150. The current managed drive system 100 redefines drive requirements of the contactor 150 in terms of dynamic current-based driver circuits that utilize a current output (as opposed to a voltage) to engage and hold the contactor 150 closed.

Contactor coil drive 110 is configured to control the current output to the contactor 150. That is, the contactor coil drive 110 is configured to utilize a high efficiency current managed drive 115 to manage a momentary high current needed to engage the contactor 150. The contactor coil drive 110 is also configured to limit the current output to a much lower value to hold the contactor 150 closed once it has engaged. The enabled switch 125 can be configured to set the output drive (e.g., the current output) on and off.

The contactor 150 can utilize a single coil that has a momentary high pull-in current and a low hold current managed by the contactor coil drive 110. The single coil design eliminates the need for a second coil and auxiliary contacts.

Note that the contactor coil drive 110 efficiently limits a coil current to a lower magnitude after a brief time period, or when the system has sensed that the contactor has engaged. This is achieved through the modulation of the voltage output to the single coil, which is in contrast to applying a full voltage available to the output drive circuit as is the case in the contemporary contactor electrical systems.

To control the current output to the single coil, the contactor coil drive 110 is configured to vary an output current limit value in real time (e.g., dynamic current-based contactor drive system). For example, the contactor coil drive 110 can output a high level of the current output to initially engage the contactor 150 and then substantially reduce the current output to a much lower value after some time period to keep the contactor 150 engaged. In each case, the output voltage from the contactor coil drive 110 is modulated to control or limit the current output delivered to the single coil.

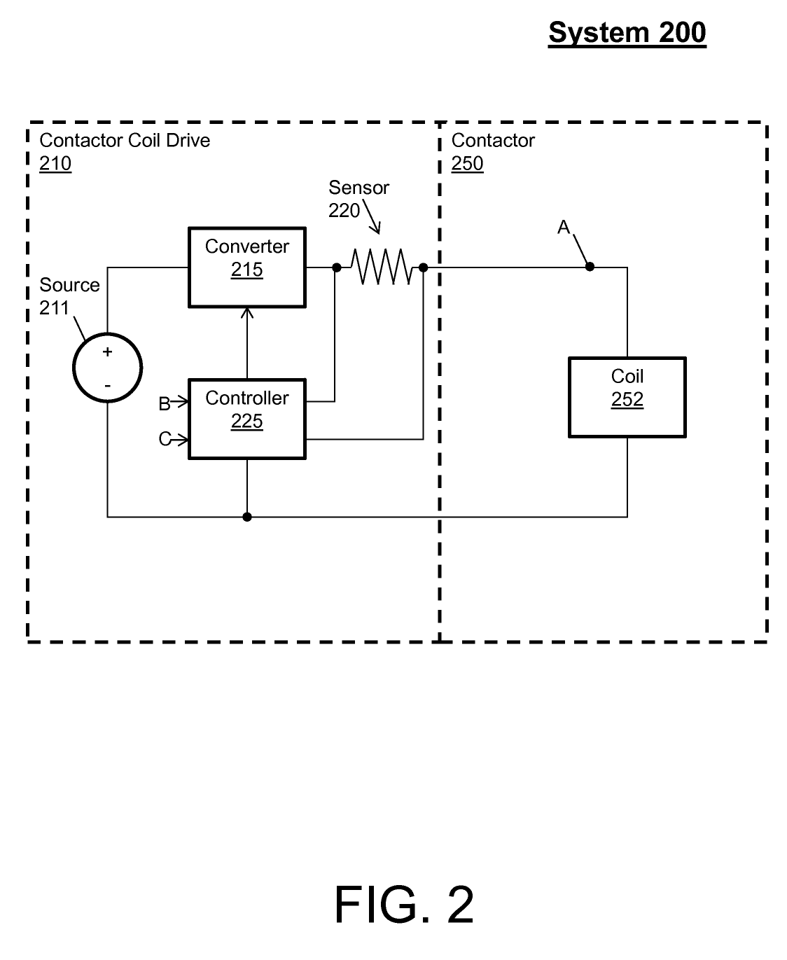

In view of the above, the system 100 and elements therein of the FIG. 1 (and other FIGs) may take many different forms and include multiple and/or alternate components and facilities. That is, while the system 100 is shown in FIG. 1, the components illustrated in FIG. 1 and other FIGS. are not intended to be limiting. Indeed, additional or alternative components and/or implementations may be used. For instance, the system 100 can perform any combination components and processes, as further described with respect to FIG. 2.

FIG. 2 illustrates a current managed drive system 200 (herein referred to as system 200) that includes a contactor coil drive 210 comprising a source 211, a converter 215, a sensor 220, and a controller 225. The system also includes a contactor 250 comprising a coil 252.

The contactor coil drive 210 is configured to control the current output to the contactor 150. The source 211 can be a direct current (DC) voltage that provides power to the system 200. The converter 215 can be a high frequency switch-mode converter that converts the DC source 211 to a variable current (e.g., which becomes the drive current at point A). The sensor 220 is a current sensor that provides feedback to the controller 225 (for regulating the drive current).

The controller 225 can be an on/off current controller that utilizes the feedback to sense a drive current value from the sensor 220 and manage the drive current via the converter 215. Note that controller 225 includes Inputs B and C. Inputs B and C, respectively, can relate to on/off and current limit command inputs to the controller. For instance, the controller 225 can manage a momentary high current needed to engage the coil 252 and then limit the drive current to a lower value to hold the coil 252 closed.

The contactor 250 can utilize a single coil, such as the coil 252, that has a momentary high pull-in current and a low hold current managed by the contactor coil drive 210. The single coil design eliminates the need for a second coil and auxiliary contacts.

Thus, the system 200 redefines drive requirements of the contactor 250 in terms of dynamic current-based driver circuits that utilize a drive current (as opposed to a voltage) originated from the source 211 to manage the coil 252. That is, the system 200, rather than driving the contactor 250 by virtue of voltage (i.e., turning on a voltage to the coil), actively manages the drive current flowing into the coil 252 (at point A).

For instance, the coil 252 can be designed to operate from 18 volts to 32.5 volts, with a nominal pull-in current of 2.5 amperes. In turn, the coil 252 is also designed to have the lowest amount of resistance (e.g., 6 ohms) such that the contactor 250 can pull in using 3 amperes of current, at a minimum voltage (18 volts), even when the coil 252 is at a hottest temperature. Also, at the highest voltage (32 volts) and when the coil 252 is cold (and at its lowest tolerance with respect to resistance), the resistance of the coil 252 can be as low as 3 ohms. Note that the system 200 could potentially provide in excess of 10 amps to the coil 252 even though it only needs 2.5 amps to operate. Passing a current in excess of 10 amps at 32 volts (over 320 watts) places an unnecessary large burden on the source 211.

Thus, rather than delivering 10 amps or more to the coil 252, the system 200 manages/reduces the drive current to, for example, 3 amps (which meets the minimum pull-in current of 2.5 amps) using a fraction of the power (that would be delivered at 32 volts) to operate the coil 252. In this example, the power delivered to the coil 252 is reduced to 27 watts (3 amps into a 3-ohm coil) from what would otherwise be over 320 watts. In this way, the system 200 significantly reduces the amount of power that the coil 252 can demand from the input source 211. This represents an extreme power saving when engaging the contactor.

Technical effects and benefits of the embodiments herein include improvements on contemporary contactor electrical systems with respect to weight, reliability, fault protection, cost and power consumption. For example, when defining the requirements for a contactor it is becoming increasingly difficult to source a maximum current while still guaranteeing operation at the contactor's minimum operating voltage. Further, when using a regular coil and simple drive circuit, the peak power that could be sourced from the system under the high-current condition results in the system power source being considerably oversized. Embodiments herein, which are based on a switched-mode power regulator, have the capability to limit the coil current to a lowest value needed to guarantee operation, independent of the system source voltage. Thus, under the conditions of a cold coil and high system voltage, a voltage output to the coil might be halved and the power sourced from the system reduced by a factor of four.

Technical effects and benefits of the embodiments herein also include an ability to manage an output current to the coil in real time, which allows the pull-in and holding current requirements for the contactor to be managed from a single coil connection. This eliminates the need for dual coils and/or connections to the contactor. That is, in contemporary contactor electrical systems, the pull-in and hold current requirements are managed using a mechanical bypass switch within the contactor, (also known as a cut-throat switch), which leaves the system vulnerable to a failure mode in which the switch fails short. This results in the low-impedance coil remaining powered until the system shuts down from overcurrent or even fails due to excessive power dissipation. Some systems employ dual contactor coils with separate drive circuits. By efficiently managing the current to a single coil the requirement for a mechanical switch, or dual coils and drive circuits, is eliminated. This leads to simpler and more flexible contactor design.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A current managed drive system for utilizing a current output to engage and hold a contactor, comprising:
the contactor comprising a single coil that has a momentary high pull-in current and a low hold current; and
a contactor coil drive configured to control the current output to the contactor to match the momentary high pull-in current to engage the contactor and the low hold current to hold the contactor.

2. The current managed drive system of claim 1, wherein the contactor coil drive is configured to utilize a high efficiency current managed drive to manage the momentary high current to engage the contactor.

3. The current managed drive system of claim 1, wherein the contactor coil drive is configured to limit the current output to the low hold current to hold the contactor closed.

4. The current managed drive system of claim 1, wherein the contactor coil drive comprising an enabled switch configured to control the current output on or off

5. The current managed drive system of claim 1, wherein the contactor coil drive is configured to vary an output current limit value in real time to initially control the current output to match the momentary high pull-in current and then substantially reduce the current output to the low hold current to hold the contactor closed.

6. The current managed drive system of claim 1, wherein the coil drive comprises:
a direct current (DC) voltage source configured to provide direct current to a converter.

7. The current managed drive system of claim 1, wherein the coil drive comprises:
a converter configured to convert a direct current (DC) voltage to a controlled current based on input from a controller,
wherein a load voltage is modulated to control the controlled current delivered to the output.

8. The current managed drive system of claim 1, wherein the coil drive comprises:
a controller configured to utilize feedback from a current sensor to manage the current output from a converter.

9. The current managed drive system of claim 1, wherein the coil drive comprises:
a current sensor configured to provide feedback to a controller,
wherein the feedback is utilized for controlling the current output off.
